(19) United States
(12) Patent Application Publication
(10) Pub. No.: US 2026/0263856 A1
(43) Pub. Date: Sep. 10, 2026

(54) FIRE SUPPRESSION AND RETARDANT METHODS USING A HIGH THIXOTROPY PRE-NEUTRALIZED RHEOLOGY MODIFIER AS A BINDER IN AN AQUEOUS SOLUTION

(71) Applicant: Strong Water Technology Co., Santa Cruz, CA (US)

(72) Inventors: Jeffrey DENHOLM, Santa Cruz, CA (US); Jacob E LAHMERS, San Francisco, CA (US)

(21) Appl. No.: 19/070,385

(22) Filed: Mar. 4, 2025

(51) Int. Cl. A62D 1/00

(52) U.S. Cl. CPC A62D 1/0035

(57) ABSTRACT

A method of fire suppression and fire protection comprising applying an aqueous solution comprising a pre-neutralized rheology modifier used as a binder of the aqueous solution to at least one of vegetation and structures. Another method of fire suppression and fire protection may include mixing water with a binder comprising a pre-neutralized rheology modifier to form an aqueous solution having a selectable degree of viscosity and pseudoplastic rheology; and applying the aqueous solution to surfaces that are on fire or that are in a path of a fire.

### BACKGROUND

There are four essential requirements for fire to exist: fuel, oxygen, heat, and chemical reaction. Disrupting any one of the four elements will extinguish fire. The term “suppression” means to extinguish fire by absorbing heat, displacing oxygen, or by isolating fuel. The term “protection” refers to preventing ignition via an insulating protective barrier that resists heat from an ignition source. One gallon of water will consume 9330 BTU (British Thermal Units) of heat as it converts to steam. But in typical firefighting operations, only 10% of all water used absorbs heat, while 90% of water falls to the ground where it does not contribute to either fire suppression or protection.

Existing solutions include class A foams, which are found on most fire trucks across the USA. Class A forms are extinguishing agents that can be used on ordinary wood, paper, and vegetation fires, but not on petroleum or chemical fires, which require Class B foams. Class A fire ground chemicals include class A foam, water enhancers, & long-term retardants. Class A foam, (essentially dish soap) has been used for decades to break down surface tension, thereby enhancing the ability of the applied water to be absorbed into a fuel source (e.g., wood, or other combustible matter). At higher concentrations, with aeration, it can produce what may be described as a white foamy blanket. This white foamy blanket was thought to extend the suppression value of water by a factor of 2. In recent modern UL based tests, however, such white foamy blankets were found to be 25% less effective than plain water in fire suppression and were found to be of no value in terms of fire protection.

Long-term fire retardants are currently composed of phosphates which, after drying, act by displacing oxygen when exposed to heat. These phosphate-containing long-term fire retardants, however, are toxic to firefighters (as attested to by currently pending mass litigation on behalf of injured firefighters) and the environment, and are corrosive to apparatus. They are typically deployed from aircraft ahead of a fire where they can dry, providing weeks of protection. They are not used or effective for home protection and are being improperly used in direct attack to fight modern day mega-wildfires. The current widely used aviation-based or aerial firefighting tactic is to drop high volumes of antiquated long-term retardant (such as the fire retardants marketed under the trade name “PHOS-CHEK”, which include long-term fire retardants, class A foams, and gels manufactured by Perimeter Solutions, of Clayton, Missouri), from large, fixed wing aircraft, in advance of a fire, at high speed and altitude, often traveling long distances with slow response times, in an attempt to slow a wildfires' progress. This is essentially playing defense. Statistics show that such tactics regularly fail to stop new wildland fire starts from growing into major conflagrations. Extremely large volumes of harmful retardant have been dumped regularly on wildfires over many decades, yet the annual loss of lives, structures and resources remains unacceptably high. In each of the last five successive years, despite massive expense on the proliferation of harmful retardants, the state of California has experienced record wildfires in terms of both total area burned and structures lost. Despite their prevalence and volume of use, such long-term retardants were not engineered to be deployed for use in Direct Attack fire suppression. In addition to being harmful to the environment, current retardant technology and the tactics for its application are failing to stop modern-day wildfires.

### Gel Technology History

Inspired by the water retention ability of baby diapers, the first fire block gel was a mixture of super-absorbent polymers (in the form of micro sponges), suspended in Mineral oil. The first generation of such fire block gels could only be applied with a garden sprayer type hose-end eductor nozzle and was not considered user friendly by fire agencies, although it did save homes threatened by wildfire. The temperamental nature of the application of such fire block gels limited their widespread adoption. Indeed, the first generation fire block gels were limited by their application systems, by their slippery nature (the suspension of Mineral oil, water and round polymers were thought to be more slippery than ice), and by their inherent toxicity. Moreover, these fire block gels stained the structures to which they were applied and were difficult to clean-up. To apply these fire block gels in the field, firefighters used cumbersome backpack injection systems that were difficult to deploy, increased the risk of fall injury risk, and prevented structural entry as the backpack injection systems were incompatible with firefighters self-contained breathing apparatus (SCBA). Collectively, these drawbacks severely limited the adoption of fire blocking gel technologies for practical firefighting use.

A second generation fire blocking gel technology was a dry powder that had to be used premixed in the fire engine's tank and included super-absorbent polymers. Unfortunately, all super-absorbent polymers swell in the presence of water, and these second generation fire blocking gels tended to block pipe routes, pumps, and hoses, taking the deploying fire apparatus out of service. Understandably, that these gels blocked their own delivery systems was their death knell in the firefighting industry. Significantly, most super-absorbent polymers do not bio-degrade, tend to persist in the environment, swelling and reappearing each time it rains. Their persistence also meant that they tended to trap water over extended periods of time, which encouraged corrosion. Other attempts at delivering a dry powder second generation fire blocking gel eliminated the slippery oil carrier and the swelling super-absorbent polymers but required batch mixing. The firefighter industry does not favor batch mixing, as batch mixing is not conducive to emergency fire operations. Batch mixing is time consuming, must be done in advance, and requires costly specialized equipment. Moreover, batch mixing of dry powder-based fire blocking gels is prone to mixing errors that may result in an over-gelled condition that can render a fire engine useless.

There is a long-felt need, therefore, for improved fire suppression and protection compositions, methods and systems that are non-toxic, non-corrosive, do not require batch mixing before use and that leverage both existing and novel delivery methods and apparatus.

### BRIEF DESCRIPTION OF THE DRAWINGS

FIG. 1 shows methods of fire suppression and fire protection comprising applying, to at least one of vegetation and structures, an aqueous solution comprising a pre-neutralized rheology modifier used as a binder, according to embodiments.

FIG. 2 is a table showing the effect of times to ignition following an application of a 1.25% binder concentration of the present Strong Water™ composition in water on sample fuel substrates with varying moisture contents, according to embodiments.

FIG. 3 is a table showing the effect of times to ignition following an application of a 1.6% binder concentration of the present Strong Water™ composition in water on sample fuel substrates with varying moisture contents, according to embodiments.

FIG. 4 is a table showing the effect of times to ignition following an application of a 2% binder concentration of the present Strong Water™ composition in water on sample fuel substrates with varying moisture contents, according to embodiments.

FIG. 5 is a table showing the effect of times to ignition following an application of deionized water, as a testing control, on sample fuel substrates with varying moisture contents.

FIG. 6 is a table showing times to ignition of untreated sample fuel substrates with varying moisture contents.

FIG. 7 is a flowchart illustrating aspects of the present methods for fire suppression and retardant methods using a high thixotropy pre-neutralized rheology modifier as a binder in an aqueous solution, according to embodiments.

### DETAILED DESCRIPTION

Many high thixotropy acrylate polymers are commercially available. These high thixotropy acrylate polymers are sold as additives that impart a pseudoplastic rheology to water-containing compositions. Examples of such additives are shown in Table 1 (there are others):

TABLE 1

| Trade Name | Manufacturer |
|---|---|
| Texipol 63-202 | Scott Bader |
| Texipol 63-259 | Scott Bader |
| Texipol, 63-450, 510, 258, 201 | Scott Bader |
| Rheovis AS-1187 | BASF |
| Rheocoat 93, 27, 66 | Arkema |
| Aristoflex AVC, Aristoflex Eco T, TAC | Clariant |
| Carbopol Ultrez 10 NF | Lubrizol |
| (Pre-Neutralized Dispersion) | |
| Carbopol Ultrez 20 NF | Lubrizol |
| (Pre-Neutralized Dispersion) | |
| Carbopol Aqua SF-1 (Pre-Neutralized | Lubrizol |
| Dispersion) | |

In general, rheology modifiers alter a fluid's resistance to flow. They are designed to alter the thickness, texture or spreadability of the product to which they are added, whether an adhesive, sealant, or facial cream. They also can affect and control the flow of the product and can dictate how evenly the product spreads, the pearlized appearance of the product or the texture of the product to the touch. These additives also can prevent the settling of suspended solids or semi-solids and may reduce or prevent the sedimentation of such suspended solids or semi-solids. This also means that the texture or apparent silkiness of the product is affected, as these additives can help to create smoother, creamier textures in the cosmetic realm, where the look and feel of a product is a significant distinguishing factor in the marketplace. Rheology modifiers such as the examples shown in Table 1 also improve the stability of the product to which they are added, by preventing the separation of particles and ensuring longevity. A pre-neutralized rheology modifier is a rheology modifier that is already neutralized and does not require pH adjustment. Existing pre-neutralized rheology modifiers, as shown in Table 1, are conventionally used in a variety of applications, including paper, coatings, and personal care products.

According to their respective manufacturers, the rheology modifiers of Table 1 are specifically designed for several broad use categories, namely industrial uses such as adhesives sealants, coatings, adhesives, as well as personal hygiene and cosmetic products. Other corner use cases include topical and ophthalmic drug delivery and shoe creams. On the industrial side, the listed applications for such additives include bituminous coatings, mastics, textured coating systems, adhesives, industrial adhesives, construction adhesives, adhesives in the packaging and woodworking industries, pressure sensitive adhesives, high-speed machine adhesives, and paper and board coatings. Within the personal hygiene consumer market, such additives are frequently used, according to their manufacturers, for creams, lotions, color cosmetics, sun protection, hair styling, antidandruff shampoos, baby shampoos, conditioning body washes, bath gels, facial cleansers, and pearlized cleansing products as they impart effective suspension and stabilization properties, as well as thickening properties, to surfactant-based personal cleansing and cosmetic products. The use cases listed immediately above are believed to represent the current finite universe of uses to which these additive products have also been applied.

Surprisingly, it has been found that pre-neutralized inverse emulsion thickeners in aqueous solutions are highly effective in another, completely unrelated field, namely firefighting, fire suppression and fire retardant purposes. Such novel use of such compositions was unexpected, functionally dissimilar to and wholly unsuggested by any of the indicated uses of such existing products.

Described and shown herein, therefore, are biodegradable non-toxic, noncarcinogenic, fire suppression technologies that offer superior capacities in direct attack of any Class A, B, or K fire. The embodiments described herein were created to advance the efforts of firefighting agencies, protect the environment, protect firefighters, and help stop the daunting modern-day megafires.

One embodiment is a pre-neutralized rheology modifier used as the main binder or a binder in an aqueous solution for use as a fire suppressant or fire protection composition. Such a composition is a high thixotropy acrylate polymer that acts as an inverse emulsion thickener that imparts a selectable degree of viscosity pseudoplastic rheology to ordinary water. Pseudoplastic rheology is the behavior of fluids that have a low viscosity at high shear rates and a high viscosity at low shear rates. This is also known as shear thinning. According to one embodiment, the composition may be or may include one or more pre-neutralized inverse emulsifiers additives for use as water enhancers for fire suppression in various environments. For ease of reference, such pre-neutralized rheology modifier used as a binder in an aqueous solution used for fire suppression and fire protection composition will hereinafter be referred by the shorthand phrase “Strong Water™ composition.” Due to the nature of these additives, the pre-neutralized rheology modifier may be readily mixed with ordinary water on-site, either for aerial, ground, or stationary use. In one implementation, a concentrate may be prepared and brought to where it is to be mixed and prepared at a predetermined concentration in water, depending upon the application. For example, the predetermined concentration of the present Strong Water™ composition to water may be within the range of 0.5% to 4% by weight. In particular, the concentration may be within the range of 0.75 to 3% by weight. In one exemplary implementation, the predetermined concentration of the pre-present neutralized rheology modifier to water may be within the range of 1% to 2% by weight.

The highly thixotropic nature of the present Strong Water™ composition allows for a gradient viscosity between about 250,000+ centipoise (cps) at rest (such as in a holding tank, for example) to about 3,000 cps with low to medium shear rates. Centipoise (cps) is a unit used to measure the viscosity of a liquid, which is its resistance to flow. A higher cps value indicates a thicker, slower-flowing liquid. In the present compositions, high shear does not inhibit the composition's mechanical properties. Advantageously, therefore, high-pressure systems (where high shear can be expected) may be used to deliver the aqueous solution where it is needed for fire suppression and protection.

The present Strong Water™ composition can be customized as required to a variety of forms and, therefore, is application agnostic depending on the fine-tuning required for application.

According to embodiments, the present Strong Water™ composition possesses the unique characteristic of substantially increasing the surface tension of water. Many existing inverse emulsion thickeners include surfactants, which act to decrease the surface tension of water. The present Strong Water™ composition, according to one embodiment, may be free of added surfactants in the polymeric binder material. This heightened surface tension of the solution of the present Strong Water™ composition as compared to water alone, positively affects the overall heat capacity of the resultant composition to between 5 to 10 times water's normal (4,184 Joules per kilogram per degree) properties, which is advantageous from a fire suppression perspective. Another unique property is its low toxicity for wildlife, which allows the dispersion of the present acrylate polymer-containing aqueous solution to be used near food and water resources, wildlife, and other ecologically sensitive or protected areas. That being the case, the present Strong Water™ composition may be deployed in a variety of situations where ordinary conventional fire suppression foam compositions would be unsuited or could cause harm to the environment, structures, and/or materiel.

Conventionally, about 90% of water and foam applied to a burn site just runs off the surfaces to which it was applied and flows to the ground, where its fire suppression effect is negligible. In direct contrast, the increased viscosity, increased surface tension of the present Strong Water™ composition coats the applied surfaces (whether vegetation or manufactured structures), to stick where applied and persist significantly longer than conventional water and foam. As the present Strong Water™ composition persists where applied, so does its fire suppression ability, protecting the underlying surfaces to which it was applied from combustion to a greater degree and for a longer period of time than is possible with conventional water and foam formulations. Moreover, depending upon the conditions on the ground, the concentration of the present Strong Water™ composition may be chosen on-the-fly, thereby enabling selectivity between a thin, fluid, low viscosity composition best suited for fire suppression and a thicker, higher viscosity and persistent gel (similar to the consistency of toothpaste, for example) that is best suited to fire protection. Use of the present Strong Water™ composition can eliminate flashover, rekindle and water loads via simple efficiency. Consequently, the present Strong Water™ composition technology for fire suppression and retardation can save homes and other structures that would otherwise be written off, due to surrounding fuel loads. Indeed, coating a home or exposure, and even the nearby fuel loads with a high viscosity Strong Water™ composition, by virtue of its heightened heat absorption capacity and increased persistence on applied surfaces, can provide enough protection to save an asset from a severe burn-over. For example, a team of five type 6 engines, one water tender, a task force leader, and a supply vehicle (flatbed with pallets of jugs or a 500 gal gel supply tender), may operate as a unit to apply a coating of the present Strong Water™ composition to “gel” homes 1-2 hours before an expected fire front, with the expectation that the present Strong Water™ composition will persist on the vertical, horizontal and slanted surfaces to which it was applied for a time period sufficient to provide significant fire protection.

Indeed, the present Strong Water™ composition may protect structures for 2 to 8 hours, depending on the circumstances and binder concentration. Temperature, humidity, and wind, as well as coating thickness (which may range from about ⅛″ to about ½″) all contribute to the persistency of the present Strong Water™ composition on surfaces to which it is applied and, therefore, to the resultant fire resistance and fire protection afforded to that surface by the present Strong Water™ composition. Ember and fire-brand showers can be rejected for hours, while a structure expected to endure a full-on burn-over should have the present Strong Water™ composition applied 1-2 hours thereto before the advancing fire front. In one implementation, 5 gallons of the present Strong Water™ composition at a 2% binder concentration, with 250 gal of water=58,000 cubic inches, applied to be about ⅜″ thick (the thickness of the gel coating) is equivalent to 154,666 square inches or 1,074 square feet of surface area. That amount will cover the frontal exposure area of most average WUI homes. The WUI is the zone of transition between unoccupied land and human development. It is the line, area, or zone where structures and other human development meet or intermingle with undeveloped wildland or vegetative fuels. The present Strong Water™ composition causes plain water to stick and stay where it is needed-on the burning material, upper ceiling surfaces (where heat accumulates), or on a material to be protected. Some performance factors can actually compound, producing improvement factors in excess of 50X. The present Strong Water™ composition also offers superior suppression metrics in direct engagement on fire due to its viscosity and ability to wrap and cling to burning objects, thereby smothering and rapidly extinguishing fire. This performance capacity is especially effective on burning vegetation (such as vegetation in the WUI, for example), where the surface area of the fuel load is irregular. This ability to cling to surfaces is especially important in areas where high velocity warm winds (such as the Santa Ana winds in Southern California) tend to strip vegetation of any applied water/foam. As conventional foams do not possess the surface tension, heat capacity and viscosity necessary to cling to vegetation, high warm winds tend to strip the vegetation in advance of the fire front, with predictable results. The present Strong Water™ composition, applied in advance of a fire, clings to the vegetation, resists winds better than conventional foam, has a higher heat capacity than conventional foam solutions to protect vegetation and allows more time for fire suppression and containment activities. Once the fire hazard has passed, the Strong Water material is easily washed off, producing little residue and does not re-foam after the water has evaporated from the system. Certain salt blends can dramatically reduce the viscosity by breaking down the polymer matrix, making cleanup streamlined.

Because it works faster and is more effective than plain water or foam, the use of the present Strong Water™ composition, according to embodiments, can reduce operation costs, reduce suppression time, run time, exposure time, and cleanup time. Indeed, use of the present Strong Water™ composition for fire suppression purposes according to the methods disclosed herein can reduce firefighter exposure and injuries and their associated costs. Additionally, use of the present Strong Water™ composition for fire suppression purposes according to the methods disclosed herein also reduces the amount of water hauled or purchased, as well minimize toxic run-off and its cleanup expenses normally associated with conventional ecologically toxic foam formulations.

### Application Modalities

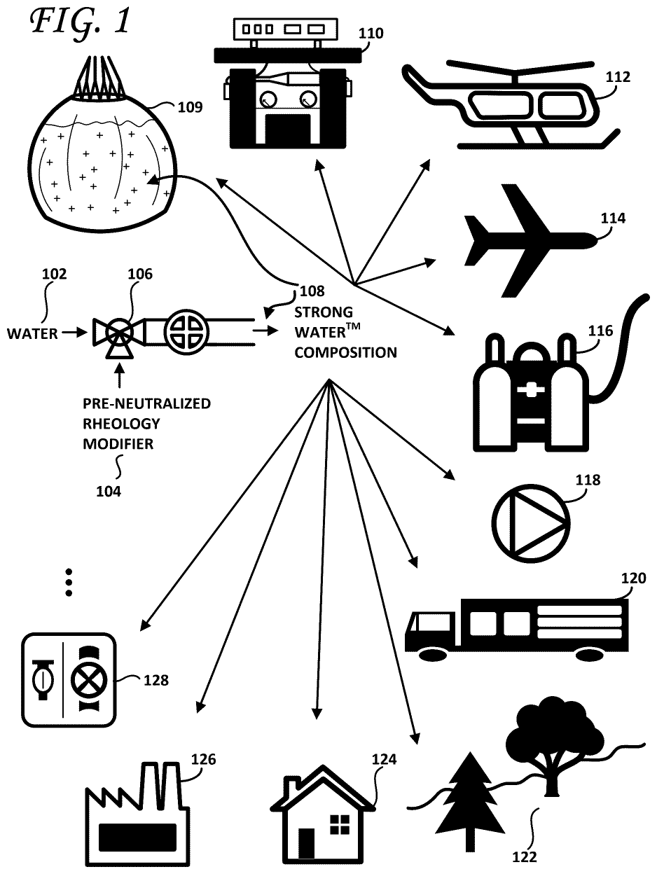

FIG. 1 shows methods of fire suppression and fire protection comprising applying, to at least one of vegetation and structures, an aqueous solution comprising a pre-neutralized rheology modifier used as a main binder, according to embodiments. As shown in FIG. 1, an existing pre-neutralized rheology modifier such as shown at 104 in FIG. 1 and in Table 1 above, conventionally developed for industrial uses such as adhesives sealants, coatings, adhesives and personal hygiene and cosmetic uses, may be advantageously repurposed, according to embodiments, as binder with water 102 at a selected concentration, to form fire suppression and fire protection Strong Water™ compositions 108 according to embodiments. For example, according to embodiments, ground-based application systems may utilize a foam proportioner 110, in which water is caused to flow through the device to produce a venturi effect that induces a foam concentrate into the water. Such foam proportioners are often used with conventional class A foams, with all the concomitant disadvantages outlined above. According to embodiments, the present Strong Water™ composition may be added to a separate tank, where the foam proportioner then mixes and creates the aqueous system. The ground firefighting vehicle may then use any dispense nozzle that would normally be used for water, as the viscosity of the solution exiting the hose ranges from about 200 to about 500 cps. Suitable foam proportioners 110 may include, but are not limited to Foam Pro model #1600, 1601 or 2001, the Leader model #2,000, and Aquis foam proportioner systems.

For example, FoamPro models 1600 & 2001/2 have been shown in studies to provide sufficient flow for useful discharge rates of the present Strong Water™ composition for fire suppression. For effective delivery of the present Strong Water™ compositions, the suction circuit of the proportioner should be at least ¾″ diameter, short (preferably less than 24″). Moreover, the injection port must be beyond (discharge port side) the flowmeter. Also, it is recommended that the Inject/Calibrate valve be relocated to the engineer's panel, so that purging/priming can be conducted as needed, without accessing a (typically) buried FoamPro system.

Other brands of powered proportioners can also be configured to apply fire suppressant Strong Water™ compositions. In contrast, “around-the-pump” proportioners are ill suited to deliver the present Strong Water™ compositions, as these around-the-pump and syphon eductors rely on a spring-loaded check valve that may become clogged as gel meets water.

Foam proportioners 110 configured for use with Strong Water™ compositions may be deployed in combating wildfires 122, suburban and urban 124 structural fires, in agriculture environments, in marine applications, (oil rig, container ship), fighting fires in airfields, in mining environments, as well as in industrial 126 and railway fire suppression efforts. In one embodiment, the amount of the pre-neutralized rheology modifier to water for fire suppression purposes may be within the range of 0.5% to 4% of the water by weight. In particular, the concentration may be within the range of 0.75% to 3% by weight. In one implementation, the predetermined concentration of the present additive to water may be within the range of 1.2% to 1.5% by weight.

Aqueous solutions containing the present high thixotropy acrylate polymer may also be used in residential or commercial sprinkler systems, such as wet pipe sprinkler systems, deluge systems, and pre-action systems 128 in a similarly effective manner. Doing so would enhance the capability of fire suppression to reduce water usage, and/or reduce hazardous chemicals like Aqueous Film Forming Foams (AFFF), dry chemical systems, high expansion foams, or gaseous suppressants.

In general, the application modalities suitable for the present Strong Water™ compositions disclosed herein for fire suppression and/or protection may fall within a predetermined number of categories, including structural applications, aerial applications, industrial applications and wildland applications, which categories are discussed in turn.

### Structural

According to embodiments, application of the present Strong Water™ compositions to structures 124, 126 may be carried out via fire sprinkler systems 128. Indeed, although at low pressure, the present Strong Water™ compositions exhibit gel-like characteristics, the higher pressure within fire suppression systems ensure that the present Strong Water™ thixotropic composition is deliverable through relatively small openings, at pressure. Indeed, the present Strong Water™ compositions' pseudoplastic rheology ensure that the compositions have a low viscosity at high shear rates within the sprinkler system 128 and a high viscosity at low shear rates, once delivered in situ. Such sprinkler systems 128 may include pendent or upright sprinkler heads, piping networks with integrated dosing of the present binder of pre-neutralized rheology modifier in water and/or automated water enhancement modules integrated into the control systems. According to a further embodiment, boluses of the present Strong Water™ compositions may be loaded into projectiles that may be lobed into a fire or in advance of a fire front for retardant purposes.

According to further embodiments, the delivery of the present Strong Water™ compositions to structures may be carried out via standpipe and fixed suppression systems. Such may include standpipe hydrants, hose reels & cabinets, distribution manifolds with built in dosing or mixing systems and/or tunnel and underground misting and suppression.

### Aerial

Aerial application of the present aqueous solution comprising a pre-neutralized rheology modifier used as the main binder for fire suppression and fire protection composition may be further categorized under rotary wing (helicopter 112) water drops and fixed wing (airplane 114) water bombing sub-categories. When applied via helicopters 112, the present Strong Water™ compositions may utilize helicopter-mounted water tanks, Bambi buckets such as shown at 109 in FIG. 1 and/or adjustable droplet control nozzles. Such adjustable droplet control nozzles may optimize binder-dosed water spray to the prevailing conditions, be it high winds, elevated temperatures, the nature of the terrain, prevailing humidity, the nature of the surfaces to which the present Strong Water™ compositions are to be applied and, for example, whether the present Strong Water™ compositions are to be applied in advance of a fire front or solely for fire suppression. In each case, the dosing may be adjusted within the mechanical and hydrological parameters of the pumps and the droplet control nozzles being utilized. Alternatively, the present Strong Water™ compositions may be pre-mixed on the ground or in a separate tank, loaded into Bambi buckets 109 or water tanks and dispensed in high volume for large-scale fire suppression. The unique nature of the Strong Water™ compositions reduces sedimentation buildup after mixing so that a homogeneous solution can be re-loaded during each vehicle refuel. This can also be true for unmanned systems (e.g., drones) or other specialty applications.

When delivered via fixed wing aircraft 114, the present Strong Water™ composition may be pre-mixed and loaded into aerial retardant tanks, equipped with precision drop control systems, and calibrated dispersal nozzles designed for consistent film formation. Again, the dosing may be adjusted within the mechanical and hydrological parameters of the control systems and the parameters associated with the dispersal nozzles being utilized. Strong Water™ presents a novel approach to large Air Tankers (LAT) and Very Large Air Tankers (VLAT) tankers, as classical water enhancers have caused gelling or gumming in tanks or lines, rendering the use of all current water enhancers restricted for use in these VLAT and LAT drops per the Red Book from the National Interagency Fire Center (NIFC).

According to embodiments the present Strong Water™ composition increases the suppression capacity of plain water by a factor of 10× in aerial applications. It does so by not only increasing the heat capacity of water but by wrapping and clinging to burning vegetation and fuel loads, thereby smothering fire.

### Aerial Delivery Examples

Using heavy lift rotary wing aircraft such as the UH-60 Blackhawk or the Sikorsky S-64, between 1,000-3,000 gallons of the present Strong Water™ composition per drop. With the suppression improvement afforded by the present Strong Water™ composition, aircraft can now deliver an unprecedented suppression capacity equivalent to 10,000 to 30,000 gallons of plain water in a single drop. With a strategically placed (near to the fire) Mobile Batch Plant (MBP), operated by QRF firefighters, a helicopter can deliver up to 8 drops per hour onto a fire, offering the ability to deliver a game changing capacity equivalent 80,000-240,000 gallons of direct attack suppression capacity per hour to the fire-front.

A single AT-802 SEAT Aircraft equipped with an 800-gallon internal tank can make 3 drops per hour, flying 8 flight hours per day means that 19,200 gallons of the present Strong Water™ composition may be deployed. This is the equivalent suppression capacity of 192,000 gallons of plain water per day.

A single Bell-214 Medium lift Helo hauling a 350-gallon Bambi-bucket makes 4 drops per hour during an 8 hour flight day can deliver 8,400 of the present Strong Water™ composition to the fire, which is the equivalent capacity of 84,000 gallons of plain water per day.

Other helicopters, such as Super Puma AS332 or Boeing CH47 Heavy lift Helos may be equipped with 1,000-3,000-gallon internal tanks and may carry out 4 drops per hour over an 8 flight hour day. These can, therefore, deliver 32,000-96,000 of the present Strong Water™ composition, yielding a suppression capacity equivalent to 320,000-960,000 gallons of plain water per day.

### Industrial

The present Strong Water™ compositions in industrial environments 126 may be deployed not only for fire suppression and retardation, but also for process cooling and the protection of equipment. For example, localized spray systems may be used, as may emergency hydrants with automated or manual water Strong Water™ enhancement dosing. Misting arrays may be configured to deliver Strong Water™ compositions to critical infrastructure assets such as transformers and electrical substations, thereby imparting these critical assets with increased heat absorption capacity and fire resistance characteristics.

The present Strong Water™ compositions may be applied for the protection of infrastructure and utility installations. Suitable delivery modes include high pressure pump systems 118, industrial water misters, cooling circuits enhanced by binder-induced film formation and heat exchanger coatings utilizing improved water retention. Other application modes may be deployed, according to the requirements on the ground.

### Wildland

The present Strong Water™ compositions may be delivered to wildland 122 (grassland, trees, and other vegetation) through the application of the present Strong Water™ compositions configured as ground-based gel/retardant using a variety of delivery systems. For instance, according to embodiments, the Strong Water™ compositions may be applied as a ground-based gel/retardant application or may be applied from the air as a short duration fire retardant. In the ground-based use case, the present Strong Water™ compositions may be applied using backpack sprayers 116, portable gel applicators, handheld misting devices and/or field mixing units. All of these may be configured to deliver aqueous formulations enhanced with a binder comprising a pre-neutralized rheology modifier according to embodiments. If delivered aerially, airborne retardant hoppers may be deployed. The present Strong Water™ compositions may also be delivered aerially using large-area sparing booms and/or other aerial distribution systems tuned for binder-modified retardants according to embodiments.

### Emergency Response

According to another embodiment, the present Strong Water™ compositions may also be delivered via rapid deployment field suppression systems and kits. Indeed, the present Strong Water™ compositions may be delivered on an emergency basis using mobile fire engines 120 equipped with pre-mixed Strong Water™ compositions or may be equipped with proportioners that deliver a solution of water and a desired amount of the present pre-neutralized rheology modifier on-demand, according to the prevailing conditions. Portable pump units may be provided that include integrated binder dosing or that are configured to pump from pre-mixed tanks of Strong Water™ compositions. According to still further embodiments, kit-based suppression systems may be provided for immediate deployment. Other emergency delivery modalities may be used.

### Building Interior/Exterior

As foreshadowed above, the present Strong Water™ compositions may advantageously be applied to building exteriors 214, 126, to provide façade cooling and protective coatings. Recall that the present Strong Water™ compositions has an overall heat capacity ranging from between 5 to 10 times water's normal heat capacity properties, which implies greater survivability for buildings and facades coated with the present Strong Water™ compositions, as the coatings are able to absorb a greater amount of heat than they would had they been coated with water alone or some short lasting foam.

Indeed, for façade cooling and protective coating applications, the present Strong Water™ compositions may be applied using fixed outdoor spray systems or high pressure misting systems. As the present Strong Water™ compositions include a high thixotropy acrylate polymer that acts as an inverse emulsion thickener that imparts a selectable degree of viscosity pseudoplastic rheology to ordinary water, the Strong Water™ compositions may be stored in holding tanks in gel form, change state to a liquid form as they are delivered via a high pressure spray or misting system, whereupon the delivered Strong Water™ compositions may revert to their gel form, clinging to the surfaces of buildings for 2-6 hours, depending upon prevailing conditions. Remote-controlled nozzle spray systems may also be used, as may cooling curtain systems configured for delivery of the present Strong Water™ compositions. Other delivery mechanisms may be deployed, as those of skill in this art may recognize. The fire retardant characteristics of the present Strong Water™ compositions alluded to above are documented by the testing data shown below. Strong Water in an atomized form can provide exceptional cooling capability, as the water droplets fan out and drastically drop heat faster, reducing the risk to firefighters in structural instances. Indeed, use of the present Strong Water™ compositions translates into higher survivability rates for firefighters when they enter a building, as it dramatically reduces the superheated layer that forms towards the upper half of the room, as compared to the use of plain water.

### Testing Data

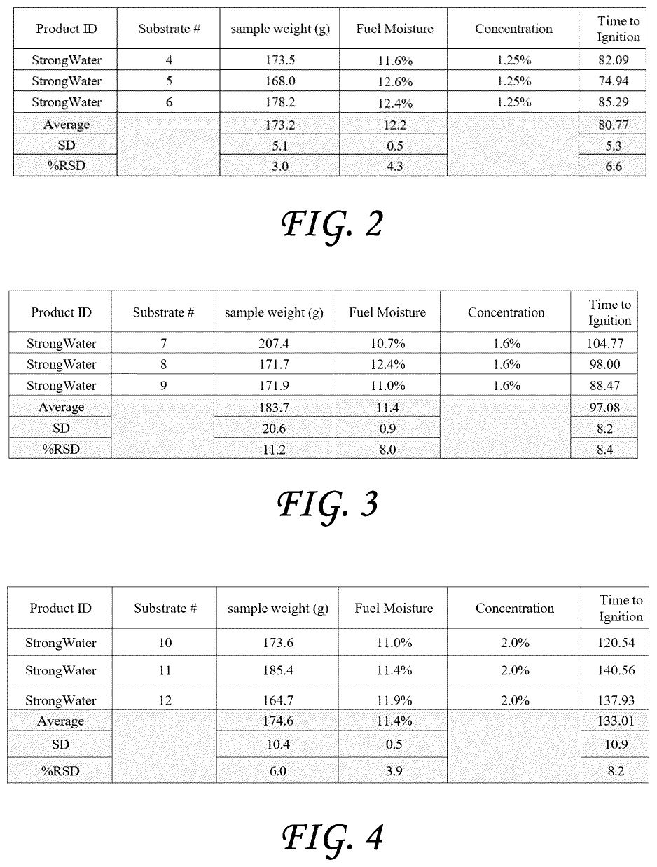

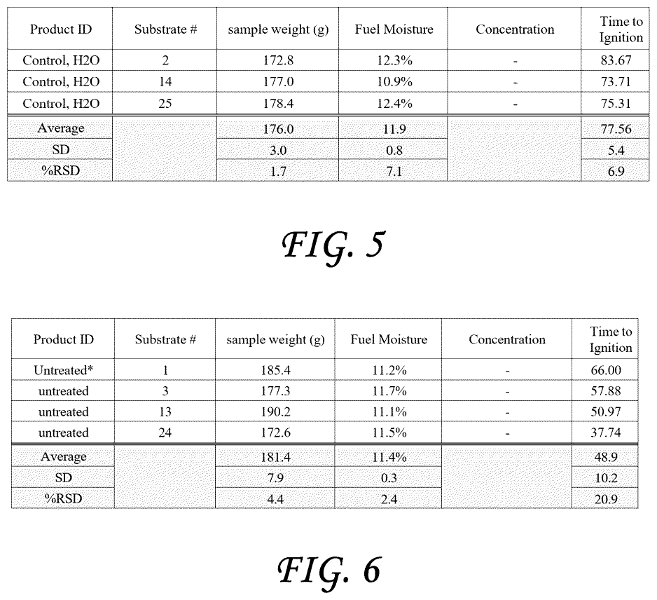

The U.S. Forest Service has conducted Lateral Ignition Flamespread Tests (LIFT) on embodiments of the present Strong Water™ compositions at various binder concentrations in accordance with Forest Service Specification 5100-306b and STP-2.2, with the results being compared to the ignition times of similar untreated fuel substrates (FIG. 6) and after application of deionized water thereto (FIG. 5). The results are shown in FIGS. 2-4.

As shown therein, increasing concentrations of the present Strong Water™ composition in water are associated with greater times to ignition of the treated fuel substrates, as compared with untreated fuel substrates of FIG. 6 and as compared with fuel substrates treated only with deionized water as shown in FIG. 5. As shown in FIG. 6, untreated fuel substrates samples with various fuel moisture percentages averaged 48.9 seconds to ignition in these tests. When deionized water was applied to the fuel samples, time to ignition increased to an average of 77.5 seconds as shown in FIG. 5. As may be seen in FIG. 2, at a concentration of 1.25% of the pre-neutralized rheology modifier used as a binder by weight relative to water, the present Strong Water™ compositions caused the time to ignition to increase to an average of 80.7 seconds. This shows an ignition reduction performance, normalized to the deionized water control case (value: 1), of 1.04. At a 1.6% concentration, the time to ignition increased to an average of 97.0 seconds, as shown in FIG. 3. This shows a more robust ignition reduction performance, normalized to the deionized water control case, of 1.25. FIG. 4 shows that, at a 2% binder concentration by weight relative to water, the present Strong Water™ compositions caused the time to ignition to increase to an average of 133 seconds. This shows a strong ignition reduction performance, normalized to the deionized water control case of FIG. 5, of 1.71, thereby demonstrating the real world fire retardant characteristics of the present embodiments.

### Protection of the Environment and Toxicity

Wildlife International has conducted Aquatic Toxicity tests in conformance with industry standards. The present Strong Water™ compositions produced no mortalities in a series of tests designed to identify a toxic concentrate level-meaning that Strong Water™ compositions are safe for the environment and those that exist in it. Indeed, many of the present Strong Water™ binder additives listed in Table 1 were designed for human use, to be used in the cosmetic industry, for facial creams, shampoos, and other consumer applications. Consequently, their lack of toxicity is well accepted. California's Proposition 65, officially known as the Safe Drinking Water and Toxic Enforcement Act of 1986, was enacted as a ballot initiative in November 1986. Prop. 65 protects the state's drinking water sources from being contaminated with chemicals known to cause cancer, birth defects or other reproductive harm, and requires businesses to inform Californians about exposures to such chemicals. The present Strong Water™ compositions have been determined to be California Proposition 65 compliant. In addition, the US Forest Service has also tested the present Strong Water™ compositions and found that the 1-year stability, mammalian toxicity, fish toxicity and biodegradability toxicity tests were all acceptable.

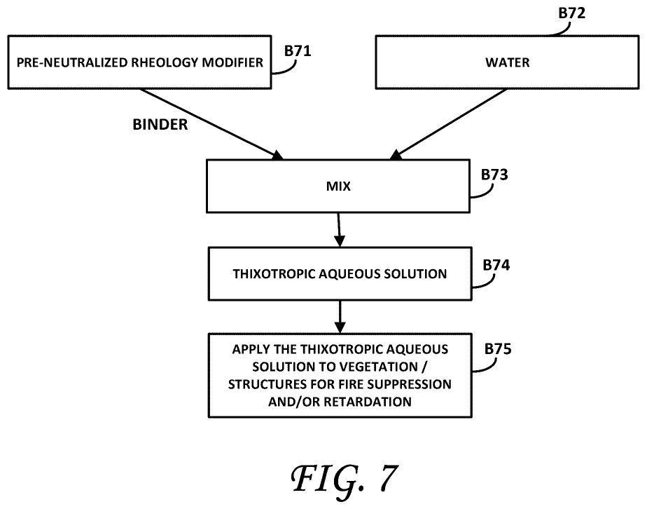

FIG. 7 is a flowchart illustrating aspects of the present methods for fire suppression and retardant methods using a high thixotropy pre-neutralized rheology modifier as a binder in an aqueous solution, according to embodiments. As shown therein, block B71 calls for providing a pre-neutralized rheology modifier. The provided pre-neutralized rheology modifier may be any of those shown in Table 1 or may be or may include other products or formulations. Water may be provided, as shown at B72. At B73, the pre-neutralized rheology modifier and the water are mixed at a selected concentration of the pre-neutralized rheology modifier as a binder in the provided water to form a thixotropic aqueous solution, as shown at B74. The mixing called for at block B73 may be carried out at the scene of the fire or well in advance thereof. At B75, the thixotropic aqueous solution may be applied to surfaces of structures, vegetation or wherever fire suppression or retardation is needed, without concern for human exposure, toxic accumulation, or runoff, as the present formulations of the aqueous solutions are bio-compatible, bio-degradable and ephemeral, having a purposefully limited effective fire suppression or retardation lifetime.

### Advantages

The present Strong Water™ compositions solve key problems that have plagued first and second-generation fire retardant gels. Moreover, the present Strong Water™ compositions find utility, beyond that offered by conventional gels & foams, in structural firefighting, where the benefits are not only environmental and economical, but also lifesaving.

### The Present Strong Water™ Compositions:

eliminate temperamental hose-end appliances required by first generation gels;
eliminate slip/fall hazards created by first generation gels;
eliminate clean-up difficulties unique to first generation gels;
can be used in structural suppression, because it does not displace SCBAs and because its viscosity can be changed readily at the pump panel. First generation products cannot be used in structural suppression;
eliminate rekindle (re-ignition of fire behind crews as they advance into a building). Eliminating rekindle is also a significant factor in wildland fire application;
eliminate flashover (condition where entire room ignites floor to ceiling, when critical temperature reaches 1100 degrees F.). Flashover is a significant killer of firefighters;
can reduce structural collapse because it reduces the amount of water and associated weight load of water, by a factor of up to 100× (the present Strong Water™ compositions float off as steam rather than accumulating in a heavy and toxic “pond”;
is not toxic to the environment or to firefighters, as are the solvents, carriers (Mineral oil), and surfactants in generation one gels, all class A foams, and long-term retardants used aviation;
can reduce water hauling requirements in rural areas because less water is required;
can reduce the time required for structural suppression, thereby reducing firefighter exposure to injury, reducing costs of suppression, mitigating property damage, and significantly reducing toxic run-off.

Significantly, the present Strong Water™ compositions can replace all first and second-generation fire block gels and class A foam, as it is uniquely viable in structural suppression, as well as wildland protection and direct attack aviation suppression.

In one embodiment, the loading of the high thixotropy acrylate polymer concentrate into water for aerial applications may be in the range of 0.5% to 4%. In particular, the concentration may be within the range of 0.75% to 3%. In one implementation, the predetermined concentration of the present additive to water may be within the range of 1.5% to 2.0%.

In another embodiment, an aqueous solution containing the present high thixotropy acrylate polymer, according to an embodiment, may also be used for hazard control and erosion protection. Indeed, the aqueous solution may be used as a mitigator for soil degradation, dust control, and heat protection before a high-temperature event.

In one implementation, the present Strong Water™ compositions may include water and a binder comprising distillates (petroleum), hydrotreated light, isotridecanol, ethoxylated and amides, C16-18 and C18-unsatd., N,N-bis(hydroxyethyl) in specific proportions, as indicated by the manufacturer. Other formulations are possible and are intended to be encompassed by the present disclosure.

One embodiment, therefore, is a method of fire suppression and fire protection comprising steps of applying an aqueous solution comprising a pre-neutralized rheology modifier used as a binder of the aqueous solution to at least one of vegetation and structures.

According to embodiments, the aqueous solution may comprise water. The pre-neutralized rheology modifier may be 0.5% to 4% by weight of the aqueous solution. The pre-neutralized rheology modifier may be 1% to 2% by weight of the aqueous solution. Applying the aqueous solution may comprise applying the aqueous solution aerially using rotary wing aircraft and/or fixed wing aircraft. The aqueous solution may be applied aerially using, for example, a Bambi bucket, or the internal and an external tank of an aircraft. The aqueous solution may alternatively be aerially using a launched projectile loaded with an amount of the aqueous solution. The aqueous solution may be applied directly to the fire or in advance of a fire front. The aqueous solution may be applied to a manufactured structure or to wilderness. The aqueous solution may be applied using a foam proportioner, a sprinkler system or a misting system, a backpack sprayer, to name but a few examples. The pre-neutralized rheology modifier used as the binder may be pre-mixed with water to create the aqueous solution.

Another embodiment is a method of fire suppression and fire protection comprising mixing water with a binder comprising a pre-neutralized rheology modifier to form an aqueous solution having a selectable degree of viscosity and pseudoplastic rheology; and applying the aqueous solution to surfaces that are on fire or that are in a path of a fire. The pre-neutralized rheology modifier may be 0.5% to 4% by weight of the aqueous solution, according to the application and prevailing conditions. In one implementation, the pre-neutralized rheology modifier may be 1% to 2% by weight of the aqueous solution. The aqueous solution may be applied aerially using rotary or fixed wing aircraft. The mixing may be carried out just before the applying step. Alternatively, mixing may be carried out (well) in advance of the applying step. The degree of viscosity may be selected to be between about 250,000 centipoise (cps) at rest to about 3,000 cps under shear.

While certain embodiments of the disclosure have been described, these embodiments have been presented by way of example only and are not intended to limit the scope of the disclosure. Indeed, the novel methods, devices and systems described herein may be embodied in a variety of other forms. Furthermore, various omissions, substitutions, and changes in the form of the methods and systems described herein may be made without departing from the spirit of the disclosure. The accompanying claims and their equivalents are intended to cover such forms or modifications as would fall within the scope and spirit of the disclosure. For example, those skilled in the art will appreciate that in various embodiments, the actual physical and logical structures may differ from those shown in the figures. Depending on the embodiment, certain steps described in the example above may be removed, others may be added. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A method of fire suppression and fire protection comprising applying an aqueous solution comprising a pre-neutralized rheology modifier used as a binder of the aqueous solution to at least one of vegetation and structures.

2. The method of claim 1, wherein the aqueous solution comprises water.

3. The method of claim 1, wherein the pre-neutralized rheology modifier is 0.5% to 4% by weight of the aqueous solution.

4. The method of claim 1, wherein the pre-neutralized rheology modifier is 1% to 2% by weight of the aqueous solution.

5. The method of claim 1, wherein applying comprises applying the aqueous solution aerially using at least one of a rotary wing aircraft and a fixed wing aircraft.

6. The method of claim 5, wherein applying comprises applying the aqueous solution using at least one or a Bambi bucket, an internal and an external tank.

7. The method of claim 1, wherein applying comprises applying the aqueous solution aerially using a launched projectile loaded with an amount of the aqueous solution.

8. The method of claim 1, wherein applying comprises applying the aqueous solution directly to a fire.

9. The method of claim 1, wherein applying comprises applying the aqueous solution in advance of a fire front.

10. The method of claim 1, wherein applying comprises applying the aqueous solution to a manufactured structure.

11. The method of claim 1, wherein applying comprises applying the aqueous solution using a foam proportioner.

12. The method of claim 1, wherein applying comprises applying the aqueous solution using a sprinkler system or a misting system.

13. The method of claim 1, wherein applying comprises applying the aqueous solution using a backpack sprayer.

14. The method of claim 1, wherein the pre-neutralized rheology modifier used as the binder is pre-mixed with water to create the aqueous solution.

15. A method of fire suppression and fire protection comprising:
mixing water with a binder comprising a pre-neutralized rheology modifier to form an aqueous solution having a selectable degree of viscosity and pseudoplastic rheology; and
applying the aqueous solution to surfaces that are on fire or that are in a path of a fire.

16. The method of claim 1, wherein the pre-neutralized rheology modifier is 0.5% to 4% by weight of the aqueous solution.

17. The method of claim 1, wherein applying comprises applying the aqueous solution aerially using at least one of a rotary wing aircraft and a fixed wing aircraft.

18. The method of claim 1, wherein mixing is carried out just before applying.

19. The method of claim 1, wherein mixing is carried in advance of applying.

20. The method of claim 1, wherein the degree of viscosity is selected to be between about 250,000 centipoise (cps) at rest to about 3,000 cps under shear.

21. The method of claim 1, further comprising cleaning the applied aqueous solution by applying a salt-containing solution to the at least one of vegetation and structures.
